(19) United States
(12) Patent Application Publication
(10) Pub. No.: US 2007/0112144 A1
(43) Pub. Date: May 17, 2007

(54) Method for decreasing gloss in molded article

(76) Inventors: Viswanathan Kalyanaraman, Athens, OH (US); Charles Lewis, Lewis Center, OH (US)

Correspondence Address: GEP-ESR APPLICATIONS, IP-LEGAL, ONE PLASTICS AVENUE, PITTSFIELD, MA, 01201-3697, US

(21) Appl. No.: 11/360,782

(22) Filed: Feb. 23, 2006

Related U.S. Application Data
(63) Continuation-in-part of application No. 10/822,620, filed on Apr. 12, 2004, now abandoned.

(51) Int. Cl. C08L 69/00

(52) U.S. Cl. 525/466; 525/468

(57) ABSTRACT

In one embodiment the present invention relates to a method for decreasing the gloss in a molded article comprising (i) at least one polycarbonate; (ii) at least one polyester; and (iii) at least one rubber modified thermoplastic resin; wherein the molded article exhibits a heat deflection temperature of at least 85° C. as measured at 1.8 MPa according to ISO 75, and a gloss value of less than or equal to about 3 as measured at an angle of 60°; and wherein the method comprises the step of preparing the article by molding using a textured mold at a mold temperature of greater than about 65° C. In other embodiments the present invention relates to molded articles.

### CROSS-REFERENCE TO RELATED APPLICATIONS

This application is a continuation-in-part of application Ser. No. 10/822,620, filed Apr. 12, 2004, which is incorporated herein by reference.

### BACKGROUND

The present invention relates to a method for decreasing gloss in a molded article comprising a polycarbonate resin, a polyester resin and a rubber modified thermoplastic resin, and molded using a mold with a textured surface. Compositions comprising a polycarbonate resin, a polyester resin and a rubber modified thermoplastic resin are known in the art. Such compositions are often used in applications which require a high heat deflection temperature (HDT) and low surface gloss in a textured surface. Frequently, however, the surface gloss in such compositions molded with textured surfaces is unsuitably high. In particular it is often found that increasing the polycarbonate content of the composition to increase HDT results in concomitant and unacceptable increase in surface gloss. In the past the problem of high surface gloss in such compositions has been addressed either by addition of a gloss-reducing additive to the composition during compounding or by painting the surface of the final article following molding. Examples of gloss-reducing additives in compositions include those described in U.S. Pat. Nos. 5,580,924 and 5,965,665. A problem to be solved is to devise a method for decreasing gloss in molded articles comprising a polycarbonate, a polyester and a rubber modified thermoplastic resin while retaining both high HDT and other desirable properties in molded parts with a textured surface without the requirement for addition of a gloss-reducing additive or for painting the surface of the final article following molding.

### BRIEF DESCRIPTION

The present inventors have discovered a method for preparing molded articles comprising a polycarbonate, a polyester and a rubber modified thermoplastic resin, which show a surprising decrease in surface gloss in molded parts with a textured surface, accompanied by a high HDT and high impact strength in the presence of increased polycarbonate loading. The compositions also possess an attractive balance of other physical properties.

In a particular embodiment the present invention relates to a method for decreasing the gloss in a molded article comprising (i) at least one polycarbonate present in a range of between about 42 wt. % and about 58 wt. %, based on the weight of resinous components in the composition; (ii) at least one polyester present in a range of between about 28 wt. % and about 50 wt. %, based on the weight of resinous components in the composition; and (iii) at least one rubber modified thermoplastic resin; wherein the wt./wt. ratio of polycarbonate to polyester is in a range of between about 68:32 and about 50:50, wherein the molded article exhibits a heat deflection temperature of at least 85° C. as measured at 1.8 MPa according to ISO 75, and a gloss value of less than or equal to about 3 as measured at an angle of 60°; and wherein the method comprises the step of preparing the article by molding using a textured mold at a mold temperature of greater than about 65° C.

In other embodiments the present invention relates to molded articles. Various other features, aspects, and advantages of the present invention will become more apparent with reference to the following description and appended claims.

### DETAILED DESCRIPTION

In the following specification and the claims which follow, reference will be made to a number of terms which shall be defined to have the following meanings. The singular forms “a”, “an” and “the” include plural referents unless the context clearly dictates otherwise. “Optional” or “optionally” means that the subsequently described event or circumstance may or may not occur, and that the description includes instances where the event occurs and instances where it does not. As used herein the term “polycarbonate” refers to polycarbonates comprising structural units derived from a carbonate precursor and at least one dihydroxy-substituted aromatic hydrocarbon, and includes copolycarbonates and polyestercarbonates.

The term “alkyl” as used in the various embodiments of the present invention is intended to designate linear alkyl, branched alkyl, aralkyl, cycloalkyl, bicycloalkyl, tricycloalkyl or polycycloalkyl radicals containing carbon and hydrogen atoms, and optionally containing atoms in addition to carbon and hydrogen, for example atoms selected from Groups 15, 16 and 17 of the Periodic Table. Alkyl groups may be saturated or unsaturated, and may comprise, for example, vinyl or allyl. The term “alkyl” also encompasses that alkyl portion of alkoxide groups. In various embodiments linear alkyl, branched alkyl, and cycloalkyl radicals are those containing from 1 to about 32 carbon atoms, and include as illustrative non-limiting examples C₁-C₃₂ alkyl, optionally substituted with one or more groups selected from C₁-C₃₂ alkyl, C₃-C₁₅ cycloalkyl or aryl; and C₃-C₁₅ cycloalkyl optionally substituted with one or more groups selected from C₁-C₃₂ alkyl or aryl. Some particular illustrative examples comprise methyl, ethyl, n-propyl, isopropyl, n-butyl, sec-butyl, tertiary-butyl, pentyl, neopentyl, hexyl, heptyl, octyl, nonyl, decyl, undecyl and dodecyl. Some illustrative non-limiting examples of cycloalkyl and bicycloalkyl radicals include cyclobutyl, cyclopentyl, cyclohexyl, methylcyclohexyl, cycloheptyl, bicycloheptyl and adamantyl. In various embodiments aralkyl radicals are those containing from 7 to about 14 carbon atoms; these include, but are not limited to, benzyl, phenylbutyl, phenylpropyl, and phenylethyl.

Polycarbonates useful in compositions of the present invention comprise structural units derived from at least one dihydroxy-substituted aromatic hydrocarbon. In various embodiments structural units derived from at least one dihydroxy-substituted aromatic hydrocarbon comprise at least about 60 percent of the total number of structural units derived from any dihydroxy-substituted hydrocarbon in the polycarbonates, and the balance of structural units derived from any dihydroxy-substituted hydrocarbon are aliphatic, alicyclic, or aromatic radicals.

In embodiments of the invention dihydroxy-substituted aromatic hydrocarbons from which structural units of polycarbonates may be derived comprise those represented by the formula (I):
HO-D-OH (I)

wherein D is a divalent aromatic radical. In some embodiments, D has the structure of formula (II):

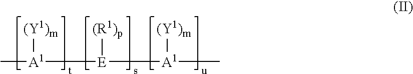

wherein A¹ represents an aromatic group including, but not limited to, phenylene, biphenylene, naphthylene and the like. In some embodiments E may be an alkylene or alkylidene group including, but not limited to, methylene, ethylene, ethylidene, propylene, propylidene, isopropylidene, butylene, butylidene, isobutylidene, amylene, amylidene, isoamylidene and the like. In other embodiments when E is an alkylene or alkylidene group, it may also consist of two or more alkylene or alkylidene groups connected by a moiety different from alkylene or alkylidene, including, but not limited to, an aromatic linkage; a tertiary nitrogen linkage; an ether linkage; a carbonyl linkage; a silicon-containing linkage, silane, siloxy; or a sulfur-containing linkage including, but not limited to, sulfide, sulfoxide, sulfone, and the like; or a phosphorus-containing linkage including, but not limited to, phosphinyl, phosphonyl, and the like. In other embodiments E may be a cycloaliphatic group including, but not limited to, cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene, and the like; a sulfur-containing linkage, including, but not limited to, sulfide, sulfoxide or sulfone; a phosphorus-containing linkage, including, but not limited to, phosphinyl or phosphonyl; an ether linkage; a carbonyl group; a tertiary nitrogen group; or a silicon-containing linkage including, but not limited to, silane or siloxy. R¹ independently at each occurrence comprises a monovalent hydrocarbon group including, but not limited to, alkenyl, allyl, alkyl, aryl, aralkyl, alkaryl, or cycloalkyl. In various embodiments the monovalent hydrocarbon group of R¹ may optionally be halogen-substituted, particularly fluoro- or chloro-substituted, for example as in dichloroalkylidene, particularly gem-dichloroalkylidene. Y¹ independently at each occurrence may be an inorganic atom including, but not limited to, halogen (fluorine, bromine, chlorine, iodine); an inorganic group containing more than one inorganic atom including, but not limited to, nitro; an organic group including, but not limited to, a monovalent hydrocarbon group including, but not limited to, alkenyl, allyl, alkyl, aryl, aralkyl, alkaryl, or cycloalkyl, or an oxy group including, but not limited to, OR² wherein R² is a monovalent hydrocarbon group including, but not limited to, alkyl, aryl, aralkyl, alkaryl, or cycloalkyl; it being only necessary that Y¹ be inert to and unaffected by the reactants and reaction conditions used to prepare the polymer. In some particular embodiments Y¹ comprises a halo group or C₁-C₆ alkyl group. The letter “m” represents any integer from and including zero through the number of replaceable hydrogens on A¹ available for substitution; “p” represents an integer from and including zero through the number of replaceable hydrogens on E available for substitution; “t” represents an integer equal to at least one; “s” represents an integer equal to either zero or one; and “u” represents any integer including zero.

In dihydroxy-substituted aromatic hydrocarbons in which D is represented by formula (II) above, when more than one Y¹ substituent is present, they may be the same or different. The same holds true for the R¹ substituent. Where “s” is zero in formula (II) and “u” is not zero, the aromatic rings are directly joined by a covalent bond with no intervening alkylidene or other bridge. The positions of the hydroxyl groups and Y¹ on the aromatic nuclear residues A¹ can be varied in the ortho, meta, or para positions and the groupings can be in vicinal, asymmetrical or symmetrical relationship, where two or more ring carbon atoms of the hydrocarbon residue are substituted with Y¹ and hydroxyl groups. In some particular embodiments the parameters “t”, “s”, and “u” each have the value of one; both A¹ radicals are unsubstituted phenylene radicals; and E is an alkylidene group such as isopropylidene. In some particular embodiments both A¹ radicals are p-phenylene, although both may be o- or m-phenylene or one o- or m-phenylene and the other p-phenylene.

In some embodiments of dihydroxy-substituted aromatic hydrocarbons E may be an unsaturated alkylidene group. Suitable dihydroxy-substituted aromatic hydrocarbons of this type include those of the formula (III):

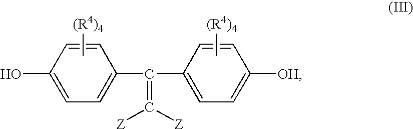

where independently each R⁴ is hydrogen, chlorine, bromine or a C₁₋₃₀ monovalent hydrocarbon or hydrocarbonoxy group, and each Z is hydrogen, chlorine or bromine, subject to the provision that at least one Z is chlorine or bromine.

Suitable dihydroxy-substituted aromatic hydrocarbons also include those of the formula (IV):

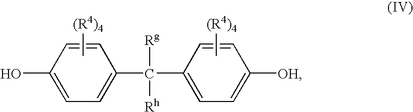

where independently each R⁴ is as defined, hereinbefore, and independently R^{g} and R^{h} are hydrogen or a C₁₋₃₀ hydrocarbon group.

In some embodiments of the present invention, dihydroxy-substituted aromatic hydrocarbons that may be used comprise those disclosed by name or formula (generic or specific) in U.S. Pat. Nos. 2,991,273, 2,999,835, 3,028,365, 3,148,172, 3,153,008, 3,271,367, 3,271,368, and 4,217,438. In other embodiments of the invention, dihydroxy-substituted aromatic hydrocarbons comprise bis(4-hydroxyphenyl)sulfide, bis(4-hydroxyphenyl)ether, bis(4-hydroxyphenyl)sulfone, bis(4-hydroxyphenyl)sulfoxide, 1,4-dihydroxybenzene, 4,4′-oxydiphenol, 2,2-bis(4-hydroxyphenyl)hexafluoropropane, 4,4′-(3,3,5-trimethylcyclohexylidene)diphenol; 4,4′-bis(3,5-dimethyl)diphenol, 1,1-bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,2-bis(4-hydroxyphenyl)ethane; 1,1-bis(4-hydroxy-2-chlorophenyl)ethane; 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; dihydroxy naphthalene; 2,6-dihydroxy naphthalene; hydroquinone; resorcinol; C₁₋₃ alkyl-substituted resorcinols; methyl resorcinol, catechol, 1,4-dihydroxy-3-methylbenzene; 2,2-bis(4-hydroxyphenyl)butane; 2,2-bis(4-hydroxyphenyl)-2-methylbutane; 1,1-bis(4-hydroxyphenyl)cyclohexane; 4,4′-dihydroxydiphenyl; 2-(3-methyl-4-hydroxyphenyl-2-(4-hydroxyphenyl)propane; 2-(3,5-dimethyl-4-hydroxyphenyl)-2-(4-hydroxyphenyl)propane; 2-(3-methyl-4-hydroxyphenyl)-2-(3,5-dimethyl-4-hydroxyphenyl)propane; bis(3,5-dimethylphenyl-4-hydroxyphenyl)methane; 1,1-bis(3,5-dimethylphenyl-4-hydroxyphenyl)ethane; 2,2-bis(3,5-dimethylphenyl-4-hydroxyphenyl)propane; 2,4-bis(3,5-dimethylphenyl-4-hydroxyphenyl)-2-methylbutane; 3,3-bis(3,5-dimethylphenyl-4-hydroxyphenyl)pentane; 1,1-bis(3,5-dimethylphenyl-4-hydroxyphenyl)cyclopentane; 1,1-bis(3,5-dimethylphenyl-4-hydroxyphenyl)cyclohexane; bis(3,5-dimethyl-4-hydroxyphenyl)sulfoxide, bis(3,5-dimethyl-4-hydroxyphenyl)sulfone and bis(3,5-dimethylphenyl-4-hydroxyphenyl)sulfide; and the like. In a particular embodiment the dihydroxy-substituted aromatic hydrocarbon comprises bisphenol A.

In some embodiments of dihydroxy-substituted aromatic hydrocarbons when E is an alkylene or alkylidene group, said group may be part of one or more fused rings attached to one or more aromatic groups bearing one hydroxy substituent. Suitable dihydroxy-substituted aromatic hydrocarbons of this type include those containing indane structural units such as represented by the formula (V), which compound is 3-(4-hydroxyphenyl)-1,1,3-trimethylindan-5-ol, and by the formula (VI), which compound is 1-(4-hydroxyphenyl)-1,3,3-trimethylindan-5-ol:

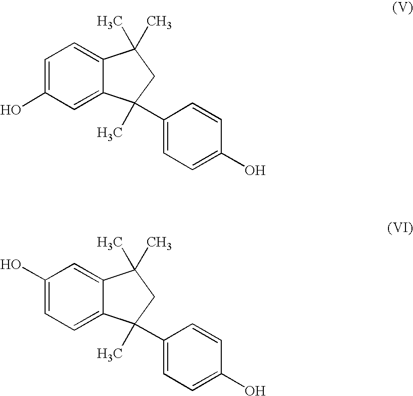

Also included among suitable dihydroxy-substituted aromatic hydrocarbons of the type comprising one or more alkylene or alkylidene groups as part of fused rings are the 2,2,2′,2′-tetrahydro-1,1′-spirobi[1H-indene]diols having formula (VII):

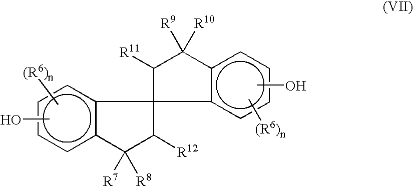

wherein each R⁶ is independently selected from monovalent hydrocarbon radicals and halogen radicals; each R⁷, R⁸, R⁹, and R¹⁰ is independently C₁₋₆ alkyl; each R¹¹ and R¹² is independently H or C₁₋₆ alkyl; and each n is independently selected from positive integers having a value of from 0 to 3 inclusive. In a particular embodiment the 2,2,2′,2′-tetrahydro-1,1′-spirobi[1H-indene]diol is 2,2,2′,2′-tetrahydro-3,3,3′,3′-tetramethyl-1,1′-spirobi[1H-indene]-6,6′-diol (sometimes known as “SBI”). Mixtures comprising at least one of any of the foregoing dihydroxy-substituted aromatic hydrocarbons may also be employed.

Polycarbonates of the invention further comprise structural units derived from at least one carbonate precursor. There is no particular limitation on the carbonate precursor. Phosgene or diphenyl carbonate are frequently used. There is no particular limitation on the method for making suitable polycarbonates. Any known process may be used. In some embodiments an interfacial process or a melt transesterification process may be used.

In one embodiment of the invention the polycarbonate comprises at least one homopolycarbonate, wherein the term “homopolycarbonate” refers to a polycarbonate synthesized using only one type of dihydroxy-substituted aromatic hydrocarbon. In particular embodiments the polycarbonate comprises a bisphenol A homo- or copolycarbonate, wherein the term “copolycarbonate” refers to a polycarbonate synthesized using more than one type of dihydroxy-substituted hydrocarbon, and in particular more than one type of dihydroxy-substituted aromatic hydrocarbon. In another particular embodiment the polycarbonate comprises a linear homopolycarbonate resin with structural units derived from bisphenol A. In other embodiments the polycarbonate comprises a blend of at least one first polycarbonate with at least one second polycarbonate differing from said first polycarbonate either in structural units, or in molecular weight, or in both these parameters. In one particular embodiment the polycarbonate comprises a mixture of a bisphenol A polycarbonate and a brominated bisphenol A polycarbonate. In still other embodiments at least one polycarbonate in the composition of the invention has a glass transition temperature, Tg, of greater than about 130° C. and preferably greater than about 140° C., as measured by differential scanning calorimetry (DSC).

Also suitable for use in the present invention are polyestercarbonates. Structural units of polyestercarbonates generally comprise carbonate groups, carboxylate groups, and aromatic carbocyclic groups in the polymer chain, in which at least some of the carboxylate groups and at least some of the carbonate groups are bonded directly to ring carbon atoms of the aromatic carbocyclic groups. These polyestercarbonates are, in general, prepared by reacting at least one dihydroxy-substituted aromatic hydrocarbon, at least one difunctional carboxylic acid or reactive derivative of the acid such as the acid dihalide, and a carbonate precursor. Suitable dihydroxy-substituted aromatic hydrocarbons include, but are not limited to, those named or referred to hereinabove. Some illustrative, non-limiting examples of suitable difunctional carboxylic acids include phthalic acid, isophthalic acid, terephthalic acid, homophthalic acid, o-, m-, and p-phenylenediacetic acid; and the polynuclear aromatic acids such as diphenic acid, 1,4-naphthalene dicarboxylic acid, 2,6-naphthalene dicarboxylic acid, and the like. These acids may be used either individually, or as a mixture of two or more different acids in the preparation of suitable polyestercarbonates. In one particular embodiment polyestercarbonates comprise structural units derived from at least one of resorcinol or an alkyl-substituted resorcinol; bisphenol A and a mixture of iso- and terephthalic acids. The polyestercarbonates which find use in the instant invention and the methods for their preparation are well known in the art as disclosed in, for example, U.S. Pat. Nos. 3,030,331; 3,169,121; 3,207,814; 4,194,038; 4,156,069; 4,238,596; 4,238,597; 4,487,896; 4,506,065; 6,265,522 and 6,559,270.

In various embodiments the weight average molecular weight of the polycarbonate ranges from about 5,000 to about 200,000. In other particular embodiments the weight average molecular weight of the polycarbonate resin is in one embodiment from about 10,000 to about 200,000 grams per mole (“g/mol”), in another embodiment from about 17,000 to about 100,000 g/mol, in another embodiment from about 18,000 to about 80,000 g/mol, in another embodiment from about 18,000 to about 40,000 g/mol, in still another embodiment from about 18,000 to about 36,000 g/mol, in still another embodiment from about 18,000 to about 30,000 g/mol, and in still another embodiment from about 18,000 to about 23,000 g/mol, all as determined by gel permeation chromatography relative to polystyrene standards. In other embodiments the weight average molecular weight of the polycarbonate ranges from about 28,000 to about 36,000 g/mol. Suitable polycarbonate resins typically exhibit an intrinsic viscosity in one embodiment of about 0.1 to about 1.5 deciliters per gram, in another embodiment of about 0.35 to about 0.9 deciliters per gram, in another embodiment of about 0.4 to about 0.6 deciliters per gram, and in still another embodiment of about 0.48 to about 0.54 deciliters per gram, all measured in methylene chloride at 25° C.

In a polycarbonate-comprising blend there may an improvement in melt flow and/or other physical properties when one molecular weight grade of a polycarbonate is combined with a proportion of a relatively lower molecular weight grade of another polycarbonate. Therefore, the present invention encompasses compositions comprising only one molecular weight grade of a polycarbonate and also compositions comprising two or more molecular weight grades of polycarbonate. The two or more polycarbonates may comprise essentially the same or different structural units. When two or more molecular weight grades of polycarbonate are present, then the weight average molecular weight of the lowest molecular weight polycarbonate is in one embodiment about 10% to about 95%, in another embodiment about 40% to about 85%, and in still another embodiment about 60% to about 80% of the weight average molecular weight of the highest molecular weight polycarbonate. In one representative, non-limiting embodiment polycarbonate-containing blends include those comprising a polycarbonate with weight average molecular weight between about 18,000 and about 24,000 combined with a polycarbonate with weight average molecular weight between about 25,000 and about 30,000 (in all cases as determined by gel permeation chromatography relative to polystyrene standards). In another representative, non-limiting embodiment polycarbonate-containing blends include those comprising a polycarbonate with weight average molecular weight between about 18,000 and about 23,000 combined with a polycarbonate with weight average molecular weight between about 28,000 and about 36,000 (in all cases as determined by gel permeation chromatography relative to polystyrene standards). When two or more molecular weight grades of polycarbonate are present, the weight ratios of the various molecular weight grades may range from about 1 to about 99 parts of one molecular weight grade and from about 99 to about 1 parts of any other molecular weight grades. In some embodiments a mixture of two molecular weight grades polycarbonate is employed, in which case the weight ratios of the two grades may range in one embodiment from about 99:1 to about 1:99, in another embodiment from about 80:20 to about 20:80, and in still another embodiment from about 70:30 to about 50:50. Since not all manufacturing processes for making a polycarbonate are capable of making all Molecular weight grades of that constituent, the present invention encompasses compositions comprising two or more molecular weight grades of polycarbonate in which each polycarbonate is made by a different manufacturing process. In one particular embodiment the instant invention encompasses compositions comprising a polycarbonate made by an interfacial process in combination with a polycarbonate of different weight average molecular weight made by a melt process.

In one embodiment the amount of polycarbonate resin present in a composition of the present invention is sufficient to provide a heat deflection temperature greater than about 85° C. as measured by ISO 75 at 1.8 MPa in a part molded in a textured mold. In another embodiment the amount of polycarbonate resin present in a composition of the present invention is sufficient to provide a surface gloss of less than or equal to about 3 when measured at a 60° angle in a part molded in a textured mold. In particular embodiments the amount of polycarbonate present in a composition of the present invention is greater than about 40 wt. %, based on the weight of resinous components in the composition, wherein the resinous components comprise polycarbonate, polyester, and rubber modified thermoplastic resin. In other particular embodiments the amount of polycarbonate present in a composition of the present invention is in a range of between about 40 wt. % and about 60 wt. %, in another embodiment in a range of between about 41 wt. % and about 59 wt. %, in another embodiment in a range of between about 42 wt. % and about 58 wt. %, and in still another embodiment in a range of between about 44 wt. % and about 59 wt. %, based on the weight of resinous components in the composition.

The compositions of the present invention further comprise at least one polyester resin. Illustrative, non-limiting examples of suitable polyester resins comprise poly(alkylene dicarboxylate)s, such as poly(ethylene terephthalate), poly(butylene terephthalate) (PBT), ionomeric poly(butylene terephthalate), poly(1,3-propylene terephthalate), poly(cyclohexanedimethanol terephthalate), poly(cyclohexanedimethanol-co-ethylene terephthalate), poly(ethylene naphthalate), poly(butylene naphthalate), and poly(1,4-cyclohexanedimethyl-1,4-cyclohexanedicarboxylate). In a particular embodiment the polyester resin is an aromatic polyester resin, and especially at least one poly(alkylene arenedioate), with poly(ethylene terephthalate) and poly(1,4-butylene terephthalate) being preferred. Mixtures of poly(alkylene dicarboxylates) may also be employed.

The amount of polyester resin present in a composition of the present invention is in one embodiment less than about 60 wt. % and preferably less than about 50 wt. %, based on the weight of resinous components in the composition. In another embodiment the amount of polyester resin present in a composition of the present invention is in a range of between about 20 wt. % and about 50 wt. %, in another embodiment in a range of between about 28 wt. % and about 50 wt. %, in still another embodiment in a range of between about 30 wt. % and about 48 wt. %, in still another embodiment in a range of between about 30 wt. % and about 47 wt. %, in still another embodiment in a range of between about 32 wt. % and about 46 wt. %, and in still another embodiment in a range of between about 34 wt. % and about 46 wt. %, based on the weight of resinous components in the composition. In still another embodiment the amount of polyester resin present in the composition is sufficient to provide a surface gloss of less than or equal to about 3 measured at an angle of 60 degrees on a test specimen molded using a textured mold. In other embodiments the amount of polyester present in the composition is sufficient to provide a wt./wt. ratio of polycarbonate to polyester in a particular embodiment in a range of between about 70:30 and about 48:52, in another particular embodiment in a range of between about 69:31 and about 49:51, in another particular embodiment in a range of between about 68:32 and about 50:50, in still another particular embodiment in a range of between about 65:35 and about 50:50 and in still another particular embodiment in a range of between about 63:37 and about 50:50.

The compositions of the present invention further comprise at least one rubber modified thermoplastic resin. In some embodiments the rubber modified thermoplastic resin comprises a discontinuous elastomeric phase and a rigid thermoplastic phase wherein at least a portion of the rigid thermoplastic phase is grafted to the elastomeric phase. The compositions may be derived from grafting at least one rubber substrate. The rubber substrate may comprise the discontinuous elastomeric phase of the composition. There is no particular limitation on the rubber substrate provided it is susceptible to grafting by at least a portion of a graftable monomer. The rubber substrate typically has a Tg in one embodiment less than or equal to 25° C., in another embodiment below about 0° C., in another embodiment below about minus 20° C., and in still another embodiment below about minus 30° C. As referred to herein, the T_{g} of a polymer is the T_{g} value as measured by differential scanning calorimetry (DSC; heating rate 20° C./minute, with the T_{g} value being determined at the inflection point).

In a one embodiment, the elastomeric phase comprises a polymer having structural units derived from one or more unsaturated monomers selected from conjugated diene monomers, non-conjugated diene monomers or (C₁-C₁₂) alkyl (meth)acrylate monomers. Suitable conjugated diene monomers include, e.g., 1,3-butadiene, isoprene, 1,3-heptadiene, methyl-1,3-pentadiene, 2,3-dimethylbutadiene, 2-ethyl-1,3-pentadiene, 1,3-hexadiene, 2,4-hexadiene, dichlorobutadiene, bromobutadiene and dibromobutadiene as well as mixtures of conjugated diene monomers. In a particular embodiment, the conjugated diene monomer is 1,3-butadiene. Suitable non-conjugated diene monomers include, e.g., ethylidene norbornene, dicyclopentadiene, hexadiene or phenyl norbornene.

As used herein, the term “(C₁-C₁₂)alkyl” means a straight or branched alkyl substituent group having from 1 to 12 carbon atoms per group and the terminology “(meth)acrylate monomers” refers collectively to acrylate monomers and methacrylate monomers. Suitable (C₁-C₁₂)alkyl(meth)acrylate monomers include (C₁-C₁₂)alkyl acrylate monomers, e.g., ethyl acrylate, butyl acrylate, iso-pentyl acrylate, n-hexyl acrylate, 2-ethyl hexyl acrylate, and their (C₁-C₁₂)alkyl methacrylate analogs such as, e.g., methyl methacrylate, ethyl methacrylate, propyl methacrylate, iso-propyl methacrylate, butyl methacrylate, hexyl methacrylate, decyl methacrylate.

The elastomeric phase may optionally include up to about 25 percent by weight (“wt. %”) of one or more monomers selected from (C₂-C₈)olefin monomers, vinyl aromatic monomers and monoethylenically unsaturated nitrile monomers. As used herein, the term “(C₂-C₈)olefin monomers” means a compound having from 2 to 8 carbon atoms per molecule and having a single site of ethylenic unsaturation per molecule. Suitable (C₂-C₈)olefin monomers include, but are not limited to, ethylene, propene, 1-butene, 1-pentene, or heptene. Suitable vinyl aromatic monomers include, but are not limited to, styrene and substituted styrenes having one or more alkyl, alkoxyl, hydroxyl or halo substituent group attached to the aromatic ring, including, but are not limited to, alpha-methyl styrene, p-methyl styrene, vinyl toluene, vinyl xylene, trimethyl styrene, butyl styrene, chlorostyrene, dichlorostyrene, bromostyrene, p-hydroxystyrene, methoxystyrene and vinyl-substituted condensed aromatic ring structures, such as, but are not limited to, vinyl naphthalene, or vinyl anthracene, as well as mixtures of vinyl aromatic monomers. As used herein, the term “monoethylenically unsaturated nitrile monomer” means an acyclic compound that includes a single nitrile group and a single site of ethylenic unsaturation per molecule such as, but are not limited to, acrylonitrile, methacrylonitrile, or alpha-chloro acrylonitrile. The elastomeric phase may, optionally, include a minor amount, for example up to about 5 wt. %, of repeating units derived from a polyethylenically unsaturated “crosslinking” monomer, such as, but are not limited to, butylene diacrylate, divinyl benzene, butene diol dimethacrylate, or trimethylolpropane tri(meth)acrylate. As used herein, the term “polyethylenically unsaturated” means having two or more sites of ethylenic unsaturation per molecule.

The elastomeric phase may, particularly in those embodiments wherein the elastomeric phase has repeating units derived from alkyl(meth)acrylate monomers, include a minor amount, e.g., up to about 5 wt. % of repeating units derived from a polyethylenically unsaturated “graftlinking” monomer. Suitable graftlinking monomers include those monomers having a first site of ethylenic unsaturation with a reactivity similar to that of the ethylenically unsaturated monomers from which the elastomeric phase is derived and a second site of ethylenic unsaturation with a relative reactivity that is substantially different from that of the ethylenically unsaturated monomers from which the elastomeric phase is derived so that the first site reacts during synthesis of the elastomeric phase and the second site is available for later reaction under different reaction conditions, e.g., during synthesis of the rigid thermoplastic phase. Suitable graftlinking monomers include, but are not limited to, allyl methacrylate, diallyl maleate, or triallyl cyanurate.

In a particular embodiment the elastomeric phase comprises from 60 wt. % to 100 wt. % repeating units derived from one or more conjugated diene monomers and from 0 wt. % to 40 wt. % repeating units derived from one or more monomers selected from vinyl aromatic monomers and monoethylenically unsaturated nitrile monomers, such as, for example, a styrene-butadiene copolymer, an acrylonitrile-butadiene copolymer or a styrene-butadiene-acrylonitrile copolymer. In another particular embodiment the elastomeric phase comprises from 70 wt. % to 90 wt. % repeating units derived from one or more conjugated diene monomers and from 30 wt. % to 10 wt. % repeating units derived from one or more monomers selected from vinyl aromatic monomers. In another particular embodiment the elastomeric phase comprises repeating units derived from one or more (C₁-C₁₂)alkyl acrylate monomers. In still another particular embodiment, the elastomeric phase comprises from 40 wt. % to 95 wt. % repeating units derived from one or more (C₁-C₁₂)alkyl acrylate monomers, more preferably from one or more monomers selected from ethyl acrylate, butyl acrylate and n-hexyl acrylate.

The elastomeric phase may be present in the rubber modified thermoplastic resin portion of compositions of the invention in one embodiment at a level of from about 4 wt. % to about 90 wt. %; in another embodiment at a level of from about 5 wt. % to about 85 wt. %; in another embodiment at a level of from about 5 wt. % to about 80 wt. %, based on the weight of the rubber modified thermoplastic resin.

In one embodiment the elastomeric phase is made by aqueous emulsion polymerization in the presence of a free radical initiator, e.g., an azonitrile initiator, an organic peroxide initiator, a persulfate initiator or a redox initiator system, and, optionally, in the presence of a chain transfer agent, e.g., an alkyl mercaptan, and coagulated to form particles of elastomeric phase material. In a particular embodiment the emulsion polymerized particles of elastomeric phase material have a weight average particle size in a range of from about 50 nanometers (nm) to about 800 nm, more preferably, in a range of from about 100 nm to about 500 nm, as measured by light transmission. The size of emulsion polymerized elastomeric particles may optionally be increased by mechanical or chemical agglomeration of the emulsion polymerized particles according to known techniques.

The rigid thermoplastic resin phase of the rubber modified thermoplastic resin comprises one or more thermoplastic polymers and exhibits a Tg of greater than 25° C., preferably greater than or equal to 90° C. and still more preferably greater than or equal to 100° C. In a particular embodiment the rigid thermoplastic phase comprises a polymer or a mixture of two or more polymers each having repeating units derived from one or more monomers selected from the group consisting of (C₁-C₁₂)alkyl (meth)acrylate monomers, vinyl aromatic monomers, and monoethylenically unsaturated nitrile monomers. Suitable (C₁-C₁₂)alkyl(meth)acrylate monomers, vinyl aromatic monomers and monoethylenically unsaturated nitrile monomers comprise those set forth above in the description of the elastomeric phase. In a preferred embodiment the rigid thermoplastic phase comprises one or more vinyl aromatic polymers. In another preferred embodiment the rigid thermoplastic resin phase comprises a vinyl aromatic polymer having first repeating units derived from one or more vinyl aromatic monomers and having second repeating units derived from one or more monoethylenically unsaturated nitrile monomers.

The rigid thermoplastic phase may be made according to known processes, e.g., mass polymerization, emulsion polymerization, suspension polymerization or combinations thereof, wherein at least a portion of the rigid thermoplastic phase is chemically bonded, i.e., “grafted” to the elastomeric phase via reaction with unsaturated sites present in the elastomeric phase. The unsaturated sites in the elastomeric phase are provided, e.g., by residual unsaturated sites in repeating units derived from a conjugated diene or by residual unsaturated sites in repeating units derived from a graftlinking monomer. In a particular embodiment at least a portion of the rigid thermoplastic phase is made by an aqueous emulsion or aqueous suspension polymerization reaction in the presence of elastomeric phase and a polymerization initiator system, e.g., a thermal or redox initiator system. In another particular embodiment at least a portion of the thermoplastic phase is made by a mass polymerization process, wherein particles of the material from which the elastomeric phase is to be formed are dispersed in a mixture of the monomers from which the rigid thermoplastic phase is to be formed and the monomers of the mixture are then polymerized to form the rubber modified thermoplastic resin. These polymerization processes may be performed in batch, semi-batch or continuous mode.

The amount of grafting that takes place between the rigid thermoplastic phase and the elastomeric phase varies with the relative amount and composition of the elastomeric phase. In one embodiment, greater than about 10 wt. % or greater than about 15 wt. % or greater than about 20 wt. % of the rigid thermoplastic phase is chemically grafted to the elastomeric phase, based on the total amount of rigid thermoplastic phase in the composition. In a particular embodiment from 5 wt. % to 90 wt. %, preferably 10 wt. % to 90 wt. %, more preferably from 30 to 80 wt. %, still more preferably 65 wt. % to 80 wt. % of the rigid thermoplastic phase is chemically grafted to the elastomeric phase and from 10 wt. % to 90 wt. %, preferably from 20 wt. % to 70 wt. %, more preferably from 20 wt. % to 35 wt. % of the rigid thermoplastic phase remains “free”, i.e., non-grafted.

The rigid thermoplastic phase of the rubber modified thermoplastic resin may be formed: in one embodiment (i) solely by polymerization carried out in the presence of the elastomeric phase or in another embodiment (ii) by addition of one or more separately polymerized rigid thermoplastic polymers to a rigid thermoplastic polymer that has been polymerized in the presence of the elastomeric phase, or in still another embodiment by both methods (i) and (ii). When at least a portion of separately polymerized rigid thermoplastic phase is added to compositions, then the amount of said separately polymerized rigid thermoplastic phase added is in an amount in a range of between about 5 wt. % and about 80 wt. % based on the weight of the rubber modified thermoplastic resin. In other embodiments no separately polymerized rigid thermoplastic polymer is added to the rubber modified thermoplastic resin.

In a preferred embodiment, the rubber modified thermoplastic resin comprises an elastomeric phase comprising a polymer having repeating units derived from one or more conjugated diene monomers, and, optionally, repeating units derived from one or more monomers selected from vinyl aromatic monomers and monoethylenically unsaturated nitrile monomers, and the rigid thermoplastic phase comprises a copolymer having repeating units derived from one or more monomers selected from vinyl aromatic monomers and monoethylenically unsaturated nitrile monomers, and optionally one or more monomers selected from the group consisting of (C₁-C₁₂)alkyl (meth)acrylate monomers.

When structural units in copolymers in the rubber modified thermoplastic resin are derived from one or more monoethylenically unsaturated nitrile monomers, then the content of said structural units derived from monoethylenically unsaturated nitrile monomer in the copolymer comprising the graft copolymer and the rigid thermoplastic phase may be in one embodiment in a range of between about 5 wt. % and about 45 wt. %, in another embodiment in a range of between about 5 wt. % and about 40 wt. %, in another embodiment in a range of between about 10 wt. % and about 40 wt. %, and in yet another embodiment in a range of between about 10 wt. % and about 30 wt. %, based on the weight of the copolymer comprising the graft copolymer and the rigid thermoplastic phase.

When structural units in copolymers in the rubber modified thermoplastic resin are derived from one or more (C₁-C₁₂)alkyl(meth)acrylate monomers, then the content of said structural units derived from (C₁-C₁₂)alkyl(meth)acrylate monomer in the copolymer comprising the graft copolymer and the rigid thermoplastic phase may be in one embodiment in a range of between about 5 wt. % and about 45 wt. %, in another embodiment in a range of between about 5 wt. % and about 40 wt. %, in another embodiment in a range of between about 10 wt. % and about 40 wt. %, and in yet another embodiment in a range of between about 10 wt. % and about 30 wt. %, based on the weight of the copolymer comprising the graft copolymer and the rigid thermoplastic phase.

In particular embodiments the rigid thermoplastic phase in the rubber modified thermoplastic resin comprises a copolymer having repeating units derived from styrene and acrylonitrile; or alpha-methyl styrene and acrylonitrile; or styrene, alpha-methyl styrene, and acrylonitrile; or styrene, acrylonitrile and methyl methacrylate; or alpha-methyl styrene, acrylonitrile and methyl methacrylate; or styrene, alpha-methyl styrene, acrylonitrile and methyl methacrylate. In another particular embodiment the rigid thermoplastic phase in the rubber modified thermoplastic resin comprises a copolymer having repeating units derived from styrene and acrylonitrile. Suitable styrene-acrylonitrile copolymers typically comprise at least 50 wt. % repeating units derived from styrene. In another particular embodiment the rigid thermoplastic phase comprises a copolymer having repeating units derived from styrene, acrylonitrile and methyl methacrylate. Suitable styrene-acrylonitrile-methyl methacrylate copolymers comprise in one embodiment about 15-40 wt. % repeating units derived from styrene; about 5-35 wt. % repeating units derived from acrylonitrile; and about 30-75 wt. % repeating units derived from methyl methacrylate.

Each of the polymers of the elastomeric phase and of the rigid thermoplastic resin phase of the rubber modified thermoplastic resin may, provided that the Tg limitation for the respective phase is satisfied, optionally include up to about 10 wt. % of third repeating units derived from one or more other copolymerizable monomers such as, e.g., monoethylenically unsaturated carboxylic acids such as, e.g., acrylic acid, methacrylic acid, itaconic acid, hydroxy(C₁-C₁₂)alkyl(meth)acrylate monomers such as, e.g., hydroxyethyl methacrylate; (C₄-C₁₂)cycloalkyl(meth)acrylate monomers such as e.g., cyclohexyl methacrylate; (meth)acrylamide monomers such as e.g., acrylamide and methacrylamide; maleimide monomers such as, e.g., N-alkyl maleimides, N-aryl maleimides, maleic anhydride, or vinyl esters such as, e.g., vinyl acetate and vinyl propionate. As used herein, the term “(C₄-C₁₂)cycloalkyl” means a cyclic alkyl substituent group having from 4 to 12 carbon atoms per group, and the term “(meth)acrylamide” refers collectively to acrylamides and methacrylamides.

Illustrative, non-limiting examples of rubber modified thermoplastic resins suitable for use in compositions of the present invention comprise ABS (acrylonitrile-butadiene-styrene), ASA (acrylate-styrene-acrylonitrile), and methyl methacrylate-modified ASA. Suitable rubber modified thermoplastic resins also comprise polycarbonate-siloxane copolymers. Illustrative, non-limiting examples of polycarbonate-siloxane copolymers and methods to prepare them are given in U.S. Pat. Nos. 3,189,662; 4,198,468; 5,194,524; 5,504,177; 5,616,674; 6,252,013; and 6,630,525. In other embodiments the rubber modified thermoplastic resin may additionally comprise MMASAN resin (methyl methacrylate-styrene-acrylonitrile resin).

The amount of rubber modified thermoplastic resin present in a composition of the present invention is in one embodiment less than about 25 wt. % and preferably less than about 20 wt. %, based on the weight of resinous components in the composition. In another embodiment the amount of rubber modified thermoplastic resin present in a composition of the present invention is in a range of between about 4 wt. % and about 25 wt. %, in another embodiment in a range of between about 4 wt. % and about 20 wt. %, in another embodiment in a range of between about 5 wt. % and about 18 wt. %, in another embodiment in a range of between about 7 wt. % and about 17 wt. %, and in still another embodiment in a range of between about 8 wt. % and about 16 wt. %, based on the weight of resinous components in the composition.

In other embodiments the amount of rubber modified thermoplastic resin present in a composition of the present invention is an amount sufficient to provide a notched Izod impact strength value of greater than about 40 kilojoules per square meter (kJ/m²) as measured by ISO180/1A at 23° C. In still other embodiments the amount of rubber modified thermoplastic resin present in a composition of the present invention is an amount sufficient to provide a notched Izod impact strength value in a range of between about 40 kJ/m² and about 70 kJ/m² as measured by ISO180/1A at 23° C. In still other embodiments the amount of rubber modified thermoplastic resin present in a composition of the present invention is an amount sufficient to provide a notched Izod impact strength value in a range of between about 10 kJ/m² and about 25 kJ/m² as measured by ISO180/1A at minus 40° C.

Compositions of the present invention may optionally comprise conventional additives known in the art including, but not limited to, stabilizers, such as color stabilizers, catalyst quenchers, transesterification inhibitors, heat stabilizers, light stabilizers, antioxidants, UV stabilizers; neutralizers; flame retardants, anti-drip agents, lubricants, flow promoters or other processing aids; plasticizers, antistatic agents, mold release agents, impact modifiers, nucleating agents, fillers, or colorants such as dyes and pigments which may be organic, inorganic or organometallic; and like additives. Illustrative additives also include, but are not limited to, silica, silicates, zeolites, titanium dioxide, stone powder, glass fibers or spheres, carbon fibers, carbon black, conductive carbon black, graphite, calcium carbonate, talc, mica, lithopone, barite, wollastonite, zinc oxide, zirconium silicate, iron oxides, diatomaceous earth, calcium carbonate, magnesium oxide, chromic oxide, zirconium oxide, aluminum oxide, crushed quartz, clay, calcined clay, organoclay, kaolin, asbestos, cellulose, wood flour, cork, cotton and synthetic textile fibers, reinforcing fillers, glass fibers, carbon fibers, conductive carbon fibers, carbon nanotubes, and metal fibers. Illustrative descriptions of such additives may be found in R. Gachter and H. Muller, Plastics Additives Handbook, 4th edition, 1993.

Often more than one additive is included in compositions of the invention, and in some embodiments more than one additive of one type is included. In a particular embodiment a composition of the invention comprises an additive selected from the group consisting of transesterification inhibitors, antioxidants, lubricants, mold release agents, stabilizers, UV stabilizers and mixtures thereof. Such additives are well known in the art and appropriate amounts may be readily determined without undue experimentation by those skilled in the art. Such additives may be added at a suitable time during the mixing of the components for forming the composition.

In another embodiment the present invention comprises methods for making the compositions disclosed herein. The compositions may be made by combining and intimately mixing the components of the composition under conditions suitable for the formation of a blend of the components, illustrative examples of which methods include, but are not limited to, melt mixing using, for example, a two-roll mill, a kneader, a Banbury mixer, a disc-pack processor, a single screw extruder or a co-rotating or counter-rotating twin-screw extruder, and then reducing the composition so formed to particulate form, for example by pelletizing or grinding the composition. Because of the availability of melt blending equipment in commercial polymer processing facilities, melt processing procedures are generally preferred. When compositions are prepared by extrusion, they may be prepared by using a single extruder having multiple feed ports along its length to accommodate the addition of the various components at different points in the mixing process. It is also sometimes advantageous to employ at least one vent port in one or more extruder sections between the feed ports to allow venting (either atmospheric or vacuum) of the melt. Those of ordinary skill in the art will be able to adjust blending times and temperatures, as well as component addition location and sequence, without undue additional experimentation.

Articles made by methods disclosed herein are also within the scope of the present invention. In a particular embodiment articles may be made from compositions of the present invention by a molding process using a mold with a textured surface. The present inventors have surprisingly found that articles molded using a mold with a textured surface show decreasing surface gloss with increasing mold temperature. Articles are made from compositions of the present invention by a molding process using a mold with a textured surface and a mold temperature of sufficient magnitude to produce a molded part with surface gloss in one embodiment of less than or equal to about 3, in another embodiment of less than about 2.5, and in another embodiment of less than about 2, as measured at an angle of 60 degrees. In particular, the mold temperature is greater than about 58° C. in one embodiment, greater than about 60° C. in another embodiment, greater than about 65° C. in another embodiment, greater than about 70° C. in another embodiment, and greater than about 80° C. in still another embodiment.

Articles which can be made which comprise compositions of the present invention include, but are not limited to, interior components for aircraft, automobiles, trucks, military vehicles, recreational vehicles, scooters, and motorcycles; wall panels and doors; indoor signs; electrical sockets; lighting appliances; reflectors; and like articles. Said articles may be prepared by a variety of known processes and fabrication steps which include, but are not limited to, profile extrusion, sheet extrusion, coextrusion, extrusion blow molding, thermoforming, injection molding, compression molding, in-mold decoration, baking in a paint oven, plating, or lamination.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

The following examples employed a bisphenol A polycarbonate with weight average molecular weight between about 18,000 and about 24,000 (PC-1); a bisphenol A polycarbonate with weight average molecular weight between about 25,000 and about 30,000 (PC-2); and a brominated bisphenol A polycarbonate comprising about 26 wt. % bromine and having a melt flow rate at 300° C. in a range of between about 5 grams per 10 minutes and about 7.85 grams per 10 minutes as measured according to ASTM D3835. The abbreviation “PBT” refers to poly(1,4-butylene terephthalate), which was VALOX 315 obtained from General Electric Plastics. The abbreviation “ABS” refers to a rubber modified thermoplastic resin prepared by an emulsion process by grafting styrene and acrylonitrile monomers to polybutadiene. The ABS comprised structural units derived from about 38.5 wt. % styrene, 11.1 wt. % acrylonitrile and 50.4 wt. % butadiene. Heat deflection temperatures (HDT) were determined according to ISO 75. Notched Izod impact strengths were determined according to ISO 180/1A. Melt volume rate (MVR) at 265° C. was determined on granulate using a 5 kilogram weight according to ISO 1133. The gloss was measured at an angle of 60 degrees on a test specimen molded using a textured mold, either General Motors type PRAIRIE-718W or General Motors type OPEL-N111. Gloss was typically measured according to standard protocols such as ASTM D 523 or DIN 67530 or ISO 2813.

### EXAMPLES 1-3 AND COMPARATIVE EXAMPLES 1-4

Compositions were prepared comprising PBT, ABS, PC-1 and either PC-2 or brominated PC. In addition the compositions comprised 0.2 parts by weight (pbw) of a transesterification inhibitor; and 1.65 parts by weight of mold release agents, antioxidants, heat stabilizers and UV screeners. In addition the compositions of the examples and comparative examples comprised 0.1 pbw carbon black. The compositions were prepared by blending components in a mixer following by extrusion using typical processing equipment at around 220-280° C. The extrudates were pelletized, dried and molded at different mold temperatures In particular the test specimens were typically molded at mold temperatures of 60° C., 71° C., and 82° C. The composition amounts in pbw and selected physical properties for molded test specimens are shown in Table 1.

TABLE 1

| | Example | | | | | | |
|---|---|---|---|---|---|---|---|
| | C. Ex. 1 | C. Ex. 2 | Ex. 1 | Ex. 2 | Ex. 3 | C. Ex. 3 | C. Ex. 4 |
| BPA-PC-1 | 24 | 24 | 20 | 30 | 33 | 36 | 39 |
| BPA-PC-2 | 16 | 16 | — | 20 | 22 | 24 | 26 |
| Brominated PC | — | — | 25 | — | — | — | — |
| PBT | 45 | 45 | 45 | 35 | 35 | 25 | 25 |
| ABS | 15 | 15 | 10 | 15 | 10 | 15 | 10 |
| HDT, ° C. at 1.8 MPa | 82 | 80 | 100 | 90 | 93 | 94 | 96 |
| Gloss at 60° angle | 1.8 (60° C.) | 1.7 (60° C.) | 3.0 (60° C.) | 3.8 (60° C.) | 5.5 (60° C.) | 8 (60° C.) | 9.2 (60° C.) |
| (mold temperature) | 1.2 (71° C.) | 1.4 (71° C.) | | 1.6 (71° C.) | 2.2 (71° C.) | 5 (71° C.) | 6.2 (71° C.) |
| | 1.1 (82° C.) | 1.3 (82° C.) | | 1.3 (82° C.) | 1.3 (82° C.) | 4 (82° C.) | 5.3 (82° C.) |
| Izod impact, | 60 | — | 50 | — | 54 | — | — |
| kJ/m² at 23° C. | | | | | | | |
| Izod impact, | 24 | — | 15 | — | 16 | — | — |
| kJ/m² at −40° C. | | | | | | | |
| MVR, cm³/10 min. | 18 | — | 15 | — | 24 | — | — |

The data for Example 1 show that a composition comprising 45 wt. % polyester and a mixture of polycarbonates, said mixture comprising a brominated polycarbonate at 25 wt. % loading, is effective to provide molded parts with surface gloss of 3, HDT value greater than 85° C., and notched Izod impact strength value greater than 40 kJ/m² at 23° C. The data for Examples 1-3 and comparative examples 1-4 show that, as the polyester level decreases in the compositions, the gloss value in test specimens increases. In addition the gloss value is significantly lower in test specimens of compositions of the invention molded at 71° C. or 82° C. mold temperature compared to those molded at 60° C. mold temperature. The data for Examples 1-3 and comparative examples 1-4 also show that, as the polycarbonate level increases in a composition, the HDT value increases. These data also indicate that the brominated polycarbonate is more effective for increasing HDT than is a comparable amount of non-brominated polycarbonate. However, when the polycarbonate level is 60 wt. % or greater based on the weight of resinous components in the composition, then the gloss level in molded parts is greater than 3 no matter how high the molding temperature is.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and Patent Applications cited herein are incorporated herein by reference.

1. A method for decreasing the gloss in a molded article comprising (i) at least one polycarbonate present in a range of between about 42 wt. % and about 58 wt. %, based on the weight of resinous components in the composition; (ii) at least one polyester present in a range of between about 28 wt. % and about 50 wt. %, based on the weight of resinous components in the composition; and (iii) at least one rubber modified thermoplastic resin;
wherein the wt./wt. ratio of polycarbonate to polyester is in a range of between about 68:32 and about 50:50, wherein the molded article exhibits a heat deflection temperature of at least 85° C. as measured at 1.8 MPa according to ISO 75, and a gloss value of less than or equal to about 3 as measured at an angle of 60°; and
wherein the method comprises the step of preparing the article by molding using a textured mold at a mold temperature of greater than about 65° C.

2. The method of claim 1, wherein the polycarbonate comprises structural units derived from at least one dihydroxy-substituted aromatic hydrocarbon represented by the formula (I):
HO-D-OH (I)
wherein D is a divalent aromatic radical with the structure of formula (II): 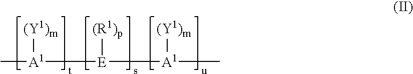
wherein A¹ is selected from the group consisting of an aromatic group, phenylene, biphenylene and naphthylene;
E is selected from the group consisting of alkylene, alkylidene, methylene, ethylene, ethylidene, propylene, propylidene, isopropylidene, butylene, butylidene, isobutylidene, amylene, amylidene, isoamylidene, a cycloaliphatic group, cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene; a sulfur-containing linkage, sulfide, sulfoxide, sulfone; a phosphorus-containing linkage, phosphinyl, phosphonyl; an ether linkage; a carbonyl group; a tertiary nitrogen group; a silicon-containing linkage, silane, siloxy; and two or more alkylene or alkylidene groups connected by a moiety different from alkylene or alkylidene and selected from the group consisting of an aromatic linkage; a tertiary nitrogen linkage; an ether linkage; a carbonyl linkage; a silicon-containing linkage, silane, siloxy; a sulfur-containing linkage, sulfide, sulfoxide, sulfone; a phosphorus-containing linkage, phosphinyl and phosphonyl;
R¹ independently at each occurrence is selected from the group consisting of a monovalent hydrocarbon group, alkenyl, allyl, alkyl, aryl, aralkyl, alkaryl, cycloalkyl, a halogen-substituted monovalent hydrocarbon group, a fluoro-substituted monovalent hydrocarbon group, a chloro-substituted monovalent hydrocarbon group, dichloroalkylidene, and gem-dichloroalkylidene,
Y¹ independently at each occurrence is selected from the group consisting of an inorganic atom, halogen, fluorine, bromine, chlorine, iodine; an inorganic group containing more than one inorganic atom, nitro; an organic group, a monovalent hydrocarbon group, alkenyl, allyl, alkyl, C₁-C₆ alkyl, aryl, aralkyl, alkaryl, cycloalkyl, and an oxy group, OR² wherein R² is a monovalent hydrocarbon group selected from the group consisting of alkyl, aryl, aralkyl, alkaryl, cycloalkyl;
“m” represents any integer from and including zero through the number of replaceable hydrogens on A¹ available for substitution;
“p” represents an integer from and including zero through the number of replaceable hydrogens on E available for substitution;
“t” represents an integer equal to at least one;
“s” represents an integer equal to either zero or one; and
“u” represents any integer including zero.

3. The method of claim 1, wherein the polycarbonate comprises structural units derived from at least one dihydroxy-substituted aromatic hydrocarbon selected from the group consisting of bis(4-hydroxyphenyl)sulfide, bis(4-hydroxyphenyl)ether, bis(4-hydroxyphenyl)sulfone, bis(4-hydroxyphenyl)sulfoxide, 1,4-dihydroxybenzene, 4,4′-oxydiphenol, 2,2-bis(4-hydroxyphenyl)hexafluoropropane, 4,4′-(3,3,5-trimethylcyclohexylidene)diphenol; 4,4′-bis(3,5-dimethyl)diphenol, 1,1-bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,2-bis(4-hydroxyphenyl)ethane; 1,1-bis(4-hydroxy-2-chlorophenyl)ethane; 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; dihydroxy naphthalene; 2,6-dihydroxy naphthalene; hydroquinone; resorcinol; C₁₋₃ alkyl-substituted resorcinols; methyl resorcinol, catechol, 1,4-dihydroxy-3-methylbenzene; 2,2-bis(4-hydroxyphenyl)butane; 2,2-bis(4-hydroxyphenyl)-2-methylbutane; 1,1-bis(4-hydroxyphenyl)cyclohexane; 4,4′-dihydroxydiphenyl; 2-(3-methyl-4-hydroxyphenyl-2-(4-hydroxyphenyl)propane; 2-(3,5-dimethyl-4-hydroxyphenyl)-2-(4-hydroxyphenyl)propane; 2-(3-methyl-4-hydroxyphenyl)-2-(3,5-dimethyl-4-hydroxyphenyl)propane; bis(3,5-dimethylphenyl-4-hydroxyphenyl)methane; 1,1-bis(3,5-dimethylphenyl-4-hydroxyphenyl)ethane; 2,2-bis(3,5-dimethylphenyl-4-hydroxyphenyl)propane; 2,4-bis(3,5-dimethylphenyl-4-hydroxyphenyl)-2-methylbutane; 3,3-bis(3,5-dimethylphenyl-4-hydroxyphenyl)pentane; 1,1-bis(3,5-dimethylphenyl-4-hydroxyphenyl)cyclopentane; 1,1-bis(3,5-dimethylphenyl-4-hydroxyphenyl)cyclohexane; bis(3,5-dimethyl-4-hydroxyphenyl)sulfoxide, bis(3,5-dimethyl-4-hydroxyphenyl)sulfone, bis(3,5-dimethylphenyl-4-hydroxyphenyl)sulfide; 3-(4-hydroxyphenyl)-1,1,3-trimethylindan-5-ol; 1-(4-hydroxyphenyl)-1,3,3-trimethylindan-5-ol; 2,2,2′,2′-tetrahydro-3,3,3′,3′-tetramethyl-1,1′-spirobi[1H-indene]-6,6′-diol, a dihydroxy-substituted aromatic hydrocarbon represented by the formula: 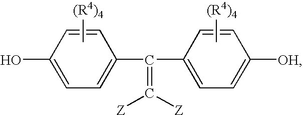
where independently each R⁴ is hydrogen, chlorine, bromine or a C₁₋₃₀ monovalent hydrocarbon or hydrocarbonoxy group, each Z is hydrogen, chlorine or bromine, subject to the provision that at least one Z is chlorine or bromine; a dihydroxy-substituted aromatic hydrocarbon represented by the formula: 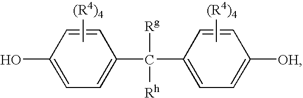
where independently each R⁴ is hydrogen, chlorine, bromine or a C₁₋₃₀ monovalent hydrocarbon or hydrocarbonoxy group, and independently R^{g} and R^{h} are hydrogen or a C₁₋₃₀ hydrocarbon group; and mixtures comprising at least one of the foregoing dihydroxy-substituted aromatic hydrocarbons.

4. The method of claim 1, wherein the polycarbonate is selected from the group consisting of bisphenol A polycarbonate, brominated bisphenol A polycarbonate, polyestercarbonates, a polyestercarbonate with structural units derived from bisphenol A, a mixture of iso- and terephthalic acids, and at least one of resorcinol or an alkyl-substituted resorcinol; and mixtures of the foregoing polycarbonates.

5. The method of claim 1, wherein the polycarbonate comprises a mixture of at least two polycarbonates.

6. The method of claim 5, wherein the mixture comprises a polycarbonate with weight average molecular weight between about 18,000 and about 24,000 g/mol in combination with a polycarbonate with weight average molecular weight between about 25,000 and about 30,000 g/mol, relative to polystyrene standards.

7. The method of claim 1, wherein the polyester is selected from the group consisting of a poly(alkylene dicarboxylate); a poly(alkylene arenedioate); poly(ethylene terephthalate), poly(butylene terephthalate), ionomeric poly(butylene terephthalate), poly(1,3-propylene terephthalate), poly(cyclohexanedimethanol terephthalate), poly(cyclohexanedimethanol-co-ethylene terephthalate), poly(ethylene naphthalate), poly(butylene naphthalate), poly(1,4-cyclohexanedimethyl-1,4-cyclohexanedicarboxylate), and mixtures thereof.

8. The method of claim 1, wherein the rubber modified thermoplastic resin comprises a discontinuous elastomeric phase dispersed in a rigid thermoplastic phase, wherein at least a portion of the rigid thermoplastic phase is grafted to the elastomeric phase, wherein the elastomeric phase comprises a polymer having structural units derived from one or more unsaturated monomers selected from the group consisting of conjugated diene monomers, non-conjugated diene monomers and (C₁-C₁₂) alkyl(meth)acrylate monomers, and wherein the rigid thermoplastic phase comprises structural units derived from at least one vinyl aromatic monomer and at least one monoethylenically unsaturated nitrile monomer.

9. The method of claim 8, wherein the unsaturated monomer comprises 1,3-butadiene.

10. The method of claim 8, wherein the elastomeric phase comprises about 4 to about 90 percent by weight of the rubber modified thermoplastic resin.

11. The method of claim 8, wherein the rigid thermoplastic phase comprises structural units derived from styrene and acrylonitrile; or alpha-methyl styrene and acrylonitrile; or styrene, alpha-methyl styrene, and acrylonitrile; or styrene, acrylonitrile and methyl methacrylate; or alpha-methyl styrene, acrylonitrile and methyl methacrylate; or styrene, alpha-methyl styrene, acrylonitrile and methyl methacrylate.

12. The method of claim 1, wherein the rubber modified thermoplastic resin is selected from the group consisting of ABS, ASA, methyl methacrylate-modified ASA, and polycarbonate-siloxane copolymer.

13. The method of claim 1, wherein the composition further comprises MMASAN.

14. The method of claim 1, wherein the rubber modified thermoplastic resin is present at a level in a range of between about 4 wt. % and about 25 wt. % based on the weight of resinous components in the composition.

15. The method of claim 1, wherein the molded article further comprises an additive selected from the group consisting of colorants, dyes, pigments, fillers, transesterification inhibitors, antioxidants, lubricants, mold release agents, stabilizers, UV stabilizers and mixtures thereof.

16. The method of claim 1, wherein the molded article possesses a notched Izod impact strength value in a range of between about 40 kJ/m² and about 70 kJ/m² as measured by ISO180/1A at 23° C.

17. A method for decreasing the gloss in a molded article comprising (i) at least one polycarbonate present in a range of between about 42 wt. % and about 58 wt. % based on the weight of resinous components in the composition and selected from the group consisting of bisphenol A polycarbonate, brominated bisphenol A polycarbonate, polyestercarbonate, and mixtures thereof; (ii) at least one aromatic polyester present in a range of between about 28 wt. % and about 50 wt. % based on the weight of resinous components in the composition and selected from the group consisting of poly(ethylene terephthalate) and poly(butylene terephthalate); and (iii) at least one rubber modified thermoplastic resin present at a level in a range of between about 4 wt. % and about 25 wt. % based on the weight of resinous components in the composition and selected from the group consisting of ABS, ASA, methyl methacrylate-modified ASA, and polycarbonate-siloxane copolymer;
wherein the wt./wt. ratio of polycarbonate to polyester is in a range of between about 68:32 and about 50:50,
wherein a molded article exhibits a heat deflection temperature of at least 85° C. as measured at 1.8 MPa according to ISO 75; a gloss value of less than or equal to about 3 as measured at an angle of 600; and a notched Izod impact strength value in a range of between about 40 kJ/m² and about 70 kJ/m² as measured by ISO 180/1A at 23° C., wherein the method comprises the step of preparing the article by molding using a textured mold at a mold temperature of greater than about 65° C.

18. The method of claim 17, wherein the article further comprises an additive selected from the group consisting of colorants, dyes, pigments, fillers, transesterification inhibitors, antioxidants, lubricants, mold release agents, stabilizers, UV stabilizers and mixtures thereof.

19. The molded article made by the method of claim 1.

20. The molded article made by the method of claim 17.
